(19) United States
(12) Patent Application Publication
(10) Pub. No.: US 2023/0004798 A1
(43) Pub. Date: Jan. 5, 2023

(54) INTENT RECOGNITION MODEL TRAINING AND INTENT RECOGNITION METHOD AND APPARATUS

(71) Applicant: BEIJING BAIDU NETCOM SCIENCE TECHNOLOGY CO., LTD., Beijing (CN)

(72) Inventors: Hongyang ZHANG, Beijing (CN); Zhenyu JIAO, Beijing (CN); Shuqi SUN, Beijing (CN); Yue CHANG, Beijing (CN); Tingting LI, Beijing (CN)

(73) Assignee: BEIJING BAIDU NETCOM SCIENCE TECHNOLOGY CO., LTD., Beijing (CN)

(21) Appl. No.: 17/825,303

(22) Filed: May 26, 2022

(30) Foreign Application Priority Data
Jun. 30, 2021 (CN) 202110736458.3

(51) Int. Cl. G06N 3/08; G06F 40/279; G06F 40/30

(52) U.S. Cl. CPC G06N 3/08; G06F 40/279; G06F 40/30

(57) ABSTRACT

The present disclosure provides intent recognition model training and intent recognition methods and apparatuses, and relates to the field of artificial intelligence technologies. The intent recognition model training method includes: acquiring training data including a plurality of training texts and first annotation intents of the plurality of training texts; constructing a neural network model including a feature extraction layer and a first recognition layer; and training the neural network model according to word segmentation results of the plurality of training texts and the first annotation intents of the plurality of training texts to obtain an intent recognition model. The method for intent recognition includes: acquiring a to-be-recognized text; and inputting word segmentation results of the to-be-recognized text to an intent recognition model, and obtaining a first intent result and a second intent result of the to-be-recognized text according to an output result of the intent recognition model.

### CROSS-REFERENCE TO RELATED APPLICATIONS

The present application claims the priority of Chinese Patent Application No. 202110736458.3, filed on Jun. 30, 2021, with the title of “INTENT RECOGNITION MODEL TRAINING AND INTENT RECOGNITION METHOD AND APPARATUS.” The disclosure of the above application is incorporated herein by reference in its entirety.

### TECHNICAL FIELD

The present disclosure relates to the field of computer technologies, and in particular, to the field of artificial intelligence technologies such as natural language processing and deep learning. Intent recognition model training and intent recognition methods and apparatuses, an electronic device and a readable storage medium are provided.

### BACKGROUND

During human-machine dialogue interaction, a machine is required to understand intents of dialogue statements. However, in the prior art, during recognition of an intent of a dialogue statement, generally, only one of a sentence-level intent and a word-level intent of the dialogue statement can be recognized, which cannot be recognized at the same time.

### SUMMARY

According to a first aspect of the present disclosure, a method is provided, including: acquiring training data including a plurality of training texts and first annotation intents of the plurality of training texts; constructing a neural network model including a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and training the neural network model according to word segmentation results of the plurality of training texts and the first annotation intents of the plurality of training texts to obtain an intent recognition model.

According to a second aspect of the present disclosure, a method for intent recognition is provided, including: acquiring a to-be-recognized text; and inputting word segmentation results of the to-be-recognized text to an intent recognition model, and obtaining a first intent result and a second intent result of the to-be-recognized text according to an output result of the intent recognition model.

According to a third aspect of the present disclosure, an electronic device is provided, including: at least one processor; and a memory communicatively connected with the at least one processor; wherein the memory stores instructions executable by the at least one processor, and the instructions are executed by the at least one processor to enable the at least one processor to perform a method, wherein the method includes: acquiring training data including a plurality of training texts and first annotation intents of the plurality of training texts; constructing a neural network model including a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and training the neural network model according to word segmentation results of the plurality of training texts and the first annotation intents of the plurality of training texts to obtain an intent recognition model.

According to a fourth aspect of the present disclosure, there is provided a non-transitory computer readable storage medium with computer instructions stored thereon, wherein the computer instructions are used for causing a method, wherein the method includes: acquiring training data including a plurality of training texts and first annotation intents of the plurality of training texts; constructing a neural network model including a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and training the neural network model according to word segmentation results of the plurality of training texts and the first annotation intents of the plurality of training texts to obtain an intent recognition model.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF THE DRAWINGS

The accompanying drawings are intended to provide a better understanding of the solutions and do not constitute a limitation on the present disclosure. In the drawings,

FIG. 1 is a schematic diagram of a first embodiment according to the present disclosure;

FIG. 2 is a schematic diagram of a second embodiment according to the present disclosure;

FIG. 3 is a schematic diagram of a third embodiment according to the present disclosure;

FIG. 4 is a schematic diagram of a fourth embodiment according to the present disclosure;

FIG. 5 is a schematic diagram of a fifth embodiment according to the present disclosure;

FIG. 6 is a schematic diagram of a sixth embodiment according to the present disclosure; and

FIG. 7 is a block diagram of an electronic device configured to perform intent recognition model training and intent recognition methods according to embodiments of the present disclosure.

### DETAILED DESCRIPTION

Exemplary embodiments of the present disclosure are illustrated below with reference to the accompanying drawings, which include various details of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

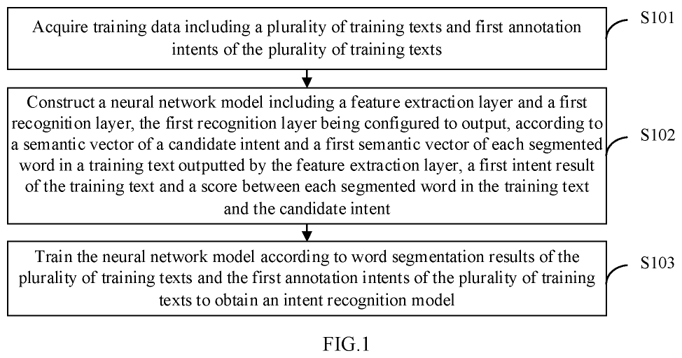

FIG. 1 is a schematic diagram of a first embodiment according to the present disclosure. As shown in FIG. 1, an intent recognition model training method according to the present disclosure may specifically include the following steps.

In S101, training data including a plurality of training texts and first annotation intents of the plurality of training texts is acquired.

In S102, a neural network model including a feature extraction layer and a first recognition layer is constructed, the first recognition layer being configured to output, according to a semantic vector of a candidate intent and a first semantic vector of each segmented word in a training text outputted by the feature extraction layer, a first intent result of the training text and a score between each segmented word in the training text and the candidate intent.

In S103, the neural network model is trained according to word segmentation results of the plurality of training texts and the first annotation intents of the plurality of training texts to obtain an intent recognition model.

In the intent recognition model training method according to this embodiment, a neural network model including a feature extraction layer and a first recognition layer is constructed, and a semantic vector of a candidate intent is set, so that the first recognition layer in the neural network model can output, according to the semantic vector of the candidate intent and an output result of the feature extraction layer, a first intent result of a training text and a score between each segmented word in the training text and the candidate intent, and an intent corresponding to each segmented word in the training text can also be obtained according to the score between each segmented word in the training text and the candidate intent. Therefore, a trained intent recognition model, in addition to being capable of recognizing a sentence-level intent of a text, is also capable of recognizing a word-level intent of the text, thereby improving recognition performance of the intent recognition model.

In this embodiment, in the training data acquired by performing S101, the first annotation intents of the plurality of training texts are annotation results of sentence-level intents of the plurality of training texts. Each training text may correspond to one first annotation intent or correspond to a plurality of first annotation intents.

For example, if a training text is “Open the navigation app and take the highway” and word segmentation results corresponding to the training text are “open”, “navigation app”, “take” and “highway”, a first annotation intent of the training text may include “NAVI” and “HIGHWAY”, and a second annotation intent of the training text may include “NAVI” corresponding to “open”, “NAVI” corresponding to “navigation app”, “HIGHWAY” corresponding to “take” and “HIGHWAY” corresponding to “highway”.

In this embodiment, after S101 is performed to acquire the training data including a plurality of training texts and first annotation intents of the plurality of training texts, S102 is performed to construct a neural network model including a feature extraction layer and a first recognition layer.

In this embodiment, when S102 is performed to construct the neural network model, a plurality of candidate intents and a semantic vector corresponding to each candidate intent may also be preset. The semantic vector of the candidate intent is configured to represent semantics of the candidate intent, which may be constantly updated with the training of the neural network model.

Specifically, in this embodiment, in the neural network model constructed by performing S102, when outputting a first semantic vector of each segmented word in a training text according to word segmentation results of the training text inputted, the feature extraction layer may adopt the following optional implementation manner. For each training text, a word vector of each segmented word in the training text is obtained. For example, the word vector of each segmented word is obtained by performing embedding processing on the segmented word. An encoding result and an attention calculation result of each segmented word are obtained according to the word vector of each segmented word. For example, the word vector is inputted to a bidirectional long short term memory (Bi-Lstm) encoder to obtain the encoding result, and the word vector is inputted to a multi-attention layer to obtain the attention calculation result. A splicing result between the encoding result and the attention calculation result of each segmented word is decoded, and a decoding result is taken as the first semantic vector of each segmented word. For example, the splicing result is inputted to a long short term memory (Lstm) decoder to obtain the decoding result.

In this embodiment, when S102 is performed to input the word vector to the multi-attention layer to obtain the attention calculation result, the word vector may be transformed by using three different linear layers, to obtain Q (queries matrices), K (keys matrices), and V (values matrices), respectively. Then, the attention calculation result of each segmented word is obtained according to the obtained Q, K and V.

In this embodiment, the attention calculation result of each segmented word may be obtained by using the following formula:

$$C = softmax ( \frac{{QK}^{T}}{\sqrt{{d}_{k}}} ) V$$

In the formula, C denotes an attention calculation result of a segmented word; Q denotes a queries matrix; K denotes a keys matrix; V denotes a values matrix; and dₖ denotes a number of segmented words.

Specifically, in this embodiment, in the neural network model constructed by performing S102, when outputting, according to a semantic vector of a candidate intent and a first semantic vector of each segmented word in a training text outputted by the feature extraction layer, a first intent result of the training text and a score between each segmented word in the training text and the candidate intent, the first recognition layer may adopt the following optional implementation manner: obtaining, for each training text according to a first semantic vector of each segmented word in the training text and the semantic vector of the candidate intent, a second semantic vector of each segmented word and a score between each segmented word and the candidate intent, wherein the score between each segmented word and the candidate intent may be an attention score between the two; and performing classification according to the second semantic vector of each segmented word, and taking a classification result as the first intent result of the training text. For example, the second semantic vector of the segmented word is inputted into a classifier after linear layer transformation, and a score of each candidate intent is obtained by the classifier. Then, the candidate intent whose score exceeds a preset threshold is selected as the first intent result of the training text.

In this embodiment, when S102 is performed to obtain the second semantic vector of each segmented word, a result obtained after linear layer transformation on the semantic vector of the candidate intent may be taken as Q, results obtained after the first semantic vector of the segmented word is transformed by two different linear layers are taken as K and V respectively, and then the second semantic vector of the segmented word is calculated according to the obtained Q, K and V.

In this embodiment, after S102 is performed to construct the neural network model including the feature extraction layer and the first recognition layer, S103 is performed to train the neural network model according to word segmentation results of the plurality of training texts and the first annotation intents of the plurality of training texts to obtain an intent recognition model.

In this embodiment, the intent recognition model trained by performing S103 can output a sentence-level intent and a word-level intent of a text according to word segmentation results of the text inputted.

Specifically, in this embodiment, when S103 is performed to train the neural network model according to word segmentation results of the plurality of training texts and the first annotation intents of the plurality of training texts to obtain an intent recognition model, the following optional implementation manner may be adopted: inputting the word segmentation results of the plurality of training texts to the neural network model to obtain a first intent result outputted by the neural network model for each training text; calculating a loss function value according to the first intent results of the plurality of training texts and the first annotation intents of the plurality of training texts; and adjusting parameters of the neural network model and the semantic vector of the candidate intent according to the calculated loss function value, and completing the training of the neural network model in a case where it is determined that the calculated loss function value converges, to obtain the intent recognition model.

That is, in this embodiment, during the training of the neural network model, the semantic vector of the candidate intent may be constantly adjusted, so that the semantic vector of the candidate intent can represent the semantics of the candidate intent more accurately, thereby improving the accuracy of the first intent result of the training text obtained according to the semantic vector of the candidate intent and the first semantic vector of each segmented word in the training text.

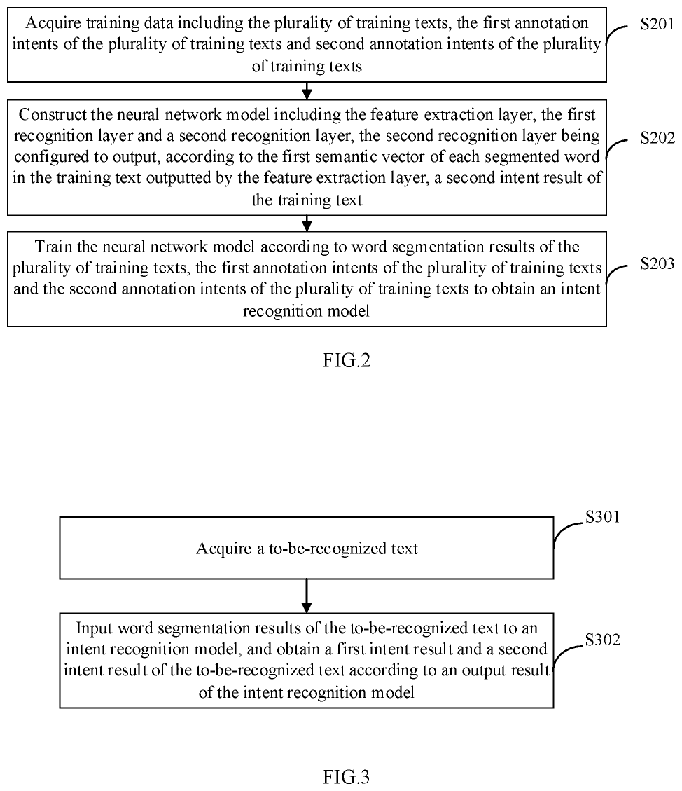

FIG. 2 is a schematic diagram of a second embodiment according to the present disclosure. As shown in FIG. 2, an intent recognition model training method according to the present disclosure may specifically include the following steps.

In S201, training data including the plurality of training texts, the first annotation intents of the plurality of training texts and second annotation intents of the plurality of training texts are acquired.

In S202, the neural network model including the feature extraction layer, the first recognition layer and a second recognition layer is constructed, the second recognition layer being configured to output, according to the first semantic vector of each segmented word in the training text outputted by the feature extraction layer, a second intent result of the training text.

In S203, the neural network model is trained according to word segmentation results of the plurality of training texts, the first annotation intents of the plurality of training texts and the second annotation intents of the plurality of training texts to obtain an intent recognition model.

That is, in this embodiment, the acquired training data may further include second annotation intents of the training texts, and a neural network model including a second recognition layer is corresponding constructed, so as to obtain an intent recognition model by training according to the training texts including the first annotation intents and the second annotation intents. Through the trained intent recognition model according to this embodiment, there is no need to obtain an intent recognition result of each segmented word in the training text according to the score between each segmented word in the training text and the candidate intent outputted by the first recognition layer, which further improves efficiency of intent recognition performed by the intent recognition model.

In this embodiment, in the training data acquired by performing S201, the second annotation intents of the plurality of training texts are word-level intents of the plurality of training texts. One segmented word in each training text corresponds to one second annotation intent.

In this embodiment, in the neural network model constructed by performing S202, when outputting, according to a first semantic vector of each segmented word in a training text outputted by the feature extraction layer, a second intent result of the training text, the second recognition layer may adopt the following optional implementation manner: for each training text, performing classification according to the first semantic vector of each segmented word in the training text, to take a classification result of each segmented word as the second intent result of the training text. For example, the first semantic vector of each segmented word is inputted into a classifier after linear layer transformation, and a score of each candidate intent is obtained by the classifier. Then, the candidate intent whose score exceeds a preset threshold is selected as the second intent result corresponding to the segmented word.

In this embodiment, when S203 is performed to train the neural network model according to word segmentation results of the plurality of training texts, the first annotation intents of the plurality of training texts and the second annotation intents of the plurality of training texts to obtain an intent recognition model, the following optional implementation manner may be adopted: inputting the word segmentation results of the plurality of training texts to the neural network model to obtain a first intent result and a second intent result outputted by the neural network model for each training text; calculating a first loss function value according to the first intent results of the plurality of training texts and the first annotation intents of the plurality of training texts, and calculating a second loss function value according to the second intent results of the plurality of training texts and the second annotation intents of the plurality of training texts; and adjusting parameters of the neural network model and the semantic vector of the candidate intent according to the calculated first loss function value and second loss function value, and completing the training of the neural network model in a case where it is determined that the calculated first loss function value and second loss function value converge, to obtain the intent recognition model.

FIG. 3 is a schematic diagram of a third embodiment according to the present disclosure. As shown in FIG. 3, an intent recognition method according to the present disclosure may specifically include the following steps.

In S301, a to-be-recognized text is acquired.

In S302, word segmentation results of the to-be-recognized text are inputted to an intent recognition model, and a first intent result and a second intent result of the to-be-recognized text are obtained according to an output result of the intent recognition model.

That is, in this embodiment, intent recognition is performed on the to-be-recognized text by using a pre-trained intent recognition model. Since the intent recognition model can output a sentence-level intent and a word-level intent of the to-be-recognized text, types of recognized intents are enriched and the accuracy of intent recognition is improved.

The intent recognition model used in this embodiment may be obtained in different training manners. If the intent recognition model is trained by constructing a neural network model including a second recognition layer and training data including second annotation intents, in this embodiment, after word segmentation results of the to-be-recognized text are inputted to the intent recognition model, the intent recognition model may output the first intent result through the first recognition layer and output the second intent result through the second recognition layer.

If the intent recognition model is not trained by constructing a neural network model including a second recognition layer and training data including second annotation intents, in this embodiment, after word segmentation results of the to-be-recognized text are inputted to the intent recognition model, the intent recognition model outputs the first intent result and scores between segmented words in the to-be-recognized text and the candidate intent through the first recognition layer. In this embodiment, when S302 is performed to obtain a second intent result according to an output result of the intent recognition model, the following optional implementation manner may be adopted: obtaining the second intent result of the to-be-recognized text according to the scores between the segmented words in the to-be-recognized text and the candidate intent outputted by the intent recognition model. For example, in this embodiment, a score matrix may be constructed according to the scores between the segmented words and the candidate intent, and the second intent result corresponding to each segmented word is obtained by conducting a search with a viterbi algorithm.

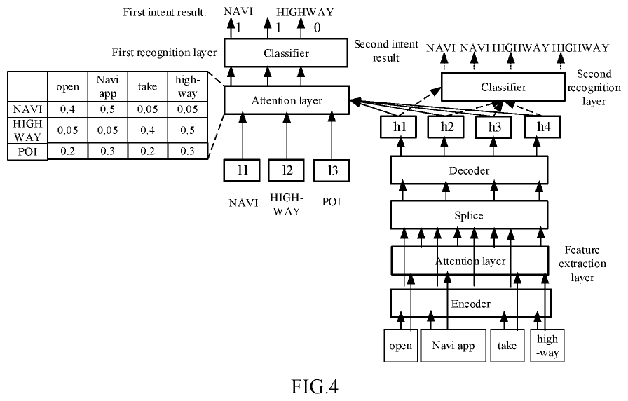

FIG. 4 is a schematic diagram of a fourth embodiment according to the present disclosure. FIG. 4 is a flowchart of intent recognition according to this embodiment. If a to-be-recognized text is “Open the navigation app and take the highway”, word segmentation results corresponding to the to-be-recognized text are “open”, “navigation app”, “take” and “highway”, and candidate intents include “NAVI”, “HIGHWAY” and “POI”, semantic vectors of the candidate intents are 11, 12 and 13 respectively. The word segmentation results corresponding to the to-be-recognized text are inputted to an intent recognition model, and a feature extraction layer in the intent recognition model passes a word vector of each word segmentation result through an encoder layer, an attention layer, a connection layer and a decoder layer to obtain a first semantic vector h1 corresponding to “open”, a first semantic vector h2 corresponding to “navigation app”, a first semantic vector h3 corresponding to “take” and a first semantic vector h4 corresponding to “highway”. Then, the first semantic vectors of the word segmentation results are inputted to a second recognition layer, to obtain second intent results corresponding to the word segmentation results outputted by the second recognition layer, which are “NAVI”, “NAVI”, “HIGHWAY” and “HIGHWAY”. The first semantic vectors of the word segmentation results and the semantic vectors of the candidate intents are inputted to a first recognition layer, to obtain first intent results corresponding to the to-be-recognized text outputted by the first recognition layer are “NAVI” and “HIGHWAY”. In addition, the first recognition layer may further output scores between the word segmentation results in the to-be-recognized text and the candidate intents, for example, the score matrix on the left of FIG. 4.

FIG. 5 is a schematic diagram of a fifth embodiment according to the present disclosure. As shown in FIG. 5, an intent recognition model training apparatus 500 according to this embodiment includes: a first acquisition unit 501 configured to acquire training data including a plurality of training texts and first annotation intents of the plurality of training texts; a construction unit 502 configured to construct a neural network model including a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and a training unit 503 configured to train the neural network model according to word segmentation results of the plurality of training texts and the first annotation intents of the plurality of training texts to obtain an intent recognition model.

In the training data acquired by the first acquisition unit 501, the first annotation intents of the plurality of training texts are annotation results of sentence-level intents of the plurality of training texts. Each training text may correspond to one first annotation intent or correspond to a plurality of first annotation intents.

When acquiring the training data, the first acquisition unit 501 may further acquire second annotation intents of the plurality of training texts, which are word-level intents of the plurality of training texts. One segmented word in each training text corresponds to one second annotation intent.

After the first acquisition unit 501 acquires the training data, the construction unit 502 constructs a neural network model including a feature extraction layer and a first recognition layer.

When the construction unit 502 constructs the neural network model, a plurality of candidate intents and a semantic vector corresponding to each candidate intent may also be preset. The semantic vector of the candidate intent is configured to represent semantics of the candidate intent, which may be constantly updated with the training of the neural network model.

Specifically, in the neural network model constructed by the construction unit 502, when outputting a first semantic vector of each segmented word in a training text according to word segmentation results of the training text inputted, the feature extraction layer may adopt the following optional implementation manner: obtaining, for each training text, a word vector of each segmented word in the training text; obtaining an encoding result and an attention calculation result of each segmented word according to the word vector of each segmented word; and decoding a splicing result between the encoding result and the attention calculation result of each segmented word, and taking a decoding result as the first semantic vector of each segmented word.

When the construction unit 502 inputs the word vector to the multi-attention layer to obtain the attention calculation result, the word vector may be transformed by using three different linear layers, to obtain Q (queries matrices), K (keys matrices), and V (values matrices), respectively. Then, the attention calculation result of each segmented word is obtained according to the obtained Q, K and V.

Specifically, in the neural network model constructed by the construction unit 502, when outputting, according to a semantic vector of a candidate intent and a first semantic vector of each segmented word in a training text outputted by the feature extraction layer, a first intent result of the training text and a score between each segmented word in the training text and the candidate intent, the first recognition layer may adopt the following optional implementation manner: obtaining, for each training text according to a first semantic vector of each segmented word in the training text and the semantic vector of the candidate intent, a second semantic vector of each segmented word and a score between each segmented word and the candidate intent, wherein the score between each segmented word and the candidate intent may be an attention score between the two; and performing classification according to the second semantic vector of each segmented word, and taking a classification result as the first intent result of the training text.

When the construction unit 502 obtains the second semantic vector of each segmented word, a result obtained after linear layer transformation on the semantic vector of the candidate intent may be taken as Q, results obtained after the first semantic vector of the segmented word is transformed by two different linear layers are taken as K and V respectively, and then the second semantic vector of the segmented word is calculated according to the obtained Q, K and V.

The construction unit 502 may further construct a neural network model including a second recognition layer, when outputting, according to a first semantic vector of each segmented word in a training text outputted by the feature extraction layer, a second intent result of the training text, the second recognition layer may adopt the following optional implementation manner: for each training text, performing classification according to the first semantic vector of each segmented word in the training text, to take a classification result of each segmented word as the second intent result of the training text.

In this embodiment, after the construction unit 502 constructs the neural network model including the feature extraction layer and the first recognition layer, the training unit 503 trains the neural network model according to word segmentation results of the plurality of training texts and the first annotation intents of the plurality of training texts to obtain an intent recognition model.

Specifically, when the training unit 503 trains the neural network model according to word segmentation results of the plurality of training texts and the first annotation intents of the plurality of training texts to obtain an intent recognition model, the following optional implementation manner may be adopted: inputting the word segmentation results of the plurality of training texts to the neural network model to obtain a first intent result outputted by the neural network model for each training text; calculating a loss function value according to the first intent results of the plurality of training texts and the first annotation intents of the plurality of training texts; and adjusting parameters of the neural network model and the semantic vector of the candidate intent according to the calculated loss function value, and completing the training of the neural network model in a case where it is determined that the calculated loss function value converges, to obtain the intent recognition model.

That is, in this embodiment, during the training of the neural network model, the semantic vector of the candidate intent may be constantly adjusted, so that the semantic vector of the candidate intent can represent the semantics of the candidate intent more accurately, thereby improving the accuracy of the first intent result of the training text obtained according to the semantic vector of the candidate intent and the first semantic vector of each segmented word in the training text.

When the training unit 503 trains the neural network model according to word segmentation results of the plurality of training texts, the first annotation intents of the plurality of training texts and the second annotation intents of the plurality of training texts to obtain an intent recognition model, the following optional implementation manner may be adopted: inputting the word segmentation results of the plurality of training texts to the neural network model to obtain a first intent result and a second intent result outputted by the neural network model for each training text; calculating a first loss function value according to the first intent results of the plurality of training texts and the first annotation intents of the plurality of training texts, and calculating a second loss function value according to the second intent results of the plurality of training texts and the second annotation intents of the plurality of training texts; and adjusting parameters of the neural network model and the semantic vector of the candidate intent according to the calculated first loss function value and second loss function value, and completing the training of the neural network model in a case where it is determined that the calculated first loss function value and second loss function value converge, to obtain the intent recognition model.

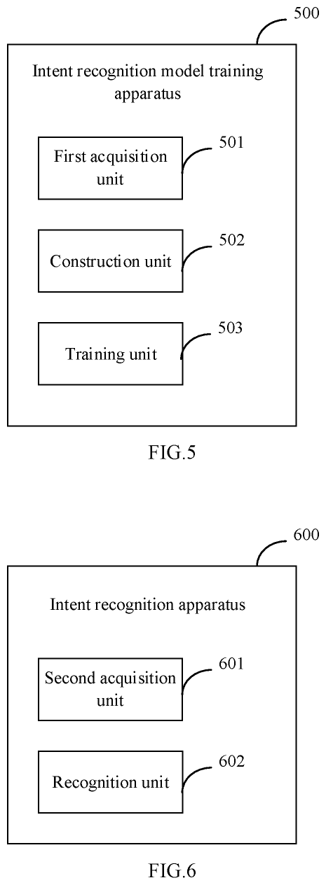

FIG. 6 is a schematic diagram of a sixth embodiment according to the present disclosure. As shown in FIG. 6, an intent recognition model training apparatus 600 according to this embodiment includes:

a second acquisition unit 601 configured to acquire a to-be-recognized text; and

a recognition unit 602 configured to input word segmentation results of the to-be-recognized text to an intent recognition model, and obtain a first intent result and a second intent result of the to-be-recognized text according to an output result of the intent recognition model.

The intent recognition model used in this embodiment may be obtained in different training manners. If the intent recognition model is trained by constructing a neural network model including a second recognition layer and training data including second annotation intents, after the recognition unit 602 inputs word segmentation results of the to-be-recognized text to the intent recognition model, the intent recognition model may output the first intent result through the first recognition layer and output the second intent result through the second recognition layer.

If the intent recognition model is not trained by constructing a neural network model including a second recognition layer and training data including second annotation intents, after the recognition unit 602 inputs word segmentation results of the to-be-recognized text to the intent recognition model, the intent recognition model outputs the first intent result and scores between segmented words in the to-be-recognized text and the candidate intent through the first recognition layer. In this embodiment, when the recognition unit 602 obtains a second intent result according to an output result of the intent recognition model, the following optional implementation manner may be adopted: obtaining the second intent result of the to-be-recognized text according to the scores between the segmented words in the to-be-recognized text and the candidate intent outputted by the intent recognition model.

Acquisition, storage and application of users' personal information involved in the technical solutions of the present disclosure comply with relevant laws and regulations, and do not violate public order and moral.

According to embodiments of the present disclosure, the present disclosure further provides an electronic device, a readable storage medium and a computer program product.

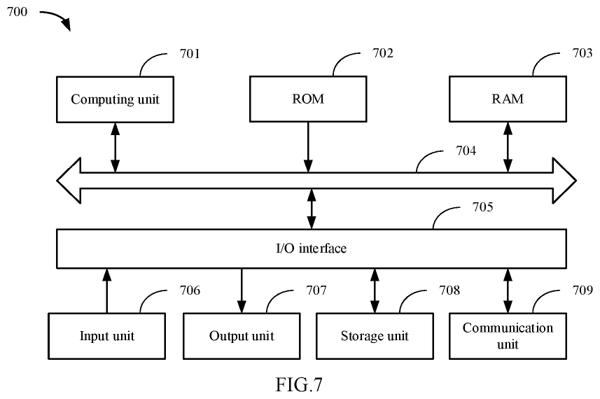

FIG. 7 is a block diagram of an electronic device configured to perform intent recognition model training and intent recognition methods according to embodiments of the present disclosure. The electronic device is intended to represent various forms of digital computers, such as laptops, desktops, workbenches, personal digital assistants, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 7, the device 700 includes a computing unit 701, which may perform various suitable actions and processing according to a computer program stored in a read-only memory (ROM) 702 or a computer program loaded from a storage unit 708 into a random access memory (RAM) 703. The RAM 703 may also store various programs and data required to operate the device 700. The computing unit 701, the ROM 702 and the RAM 703 are connected to one another by a bus 704. An input/output (I/O) interface 705 may also be connected to the bus 704.

A plurality of components in the device 700 are connected to the I/O interface 705, including an input unit 706, such as a keyboard and a mouse; an output unit 707, such as various displays and speakers; a storage unit 708, such as disks and discs; and a communication unit 709, such as a network card, a modem and a wireless communication transceiver. The communication unit 709 allows the device 700 to exchange information/data with other devices over computer networks such as the Internet and/or various telecommunications networks.

The computing unit 701 may be a variety of general-purpose and/or special-purpose processing components with processing and computing capabilities. Some examples of the computing unit 701 include, but are not limited to, a central processing unit (CPU), a graphics processing unit (GPU), various artificial intelligence (AI) computing chips, various computing units that run machine learning model algorithms, a digital signal processor (DSP), and any appropriate processor, controller or microcontroller, etc. The computing unit 701 performs the methods and processing described above, such as the operator registration method for a deep learning framework. For example, in some embodiments, the intent recognition model training and intent recognition methods may be implemented as a computer software program that is tangibly embodied in a machine-readable medium, such as the storage unit 708.

In some embodiments, part or all of a computer program may be loaded and/or installed on the device 700 via the ROM 702 and/or the communication unit 709. One or more steps of the intent recognition model training and intent recognition methods described above may be performed when the computer program is loaded into the RAM 703 and executed by the computing unit 701. Alternatively, in other embodiments, the computing unit 701 may be configured to perform the intent recognition model training and intent recognition methods described in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a load programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combinations thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, voice input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN) and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, also known as a cloud computing server or cloud host, which is a host product in the cloud computing service system to solve the problems of difficult management and weak business scalability in the traditional physical host and a virtual private server (VPS). The server may also be a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the extent of protection of the present disclosure.

What is claimed is:

1. A method, comprising:
acquiring training data comprising a plurality of training texts and first annotation intents of the plurality of training texts;
constructing a neural network model comprising a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and
training the neural network model according to word segmentation results of the plurality of training texts and the first annotation intents of the plurality of training texts to obtain an intent recognition model.

2. The method according to claim 1, wherein the step of outputting, by the feature extraction layer, a first semantic vector of each segmented word in a training text comprises:
obtaining, for each training text, a word vector of each segmented word in the training text;
obtaining an encoding result and an attention calculation result of each segmented word according to the word vector of each segmented word; and
decoding a splicing result between the encoding result and the attention calculation result of each segmented word, and taking a decoding result as the first semantic vector of each segmented word.

3. The method according to claim 1, wherein the step of outputting, by the first recognition layer according to a semantic vector of a candidate intent and a first semantic vector of each segmented word in a training text outputted by the feature extraction layer, a first intent result of the training text and a score between each segmented word in the training text and the candidate intent comprises:
obtaining, for each training text according to a first semantic vector of each segmented word in the training text and the semantic vector of the candidate intent, a second semantic vector of each segmented word and a score between each segmented word and the candidate intent; and
performing classification according to the second semantic vector of each segmented word, and taking a classification result as the first intent result of the training text.

4. The method according to claim 1, wherein the step of training the neural network model according to word segmentation results of the plurality of training texts and the first annotation intents of the plurality of training texts to obtain an intent recognition model comprises:
inputting the word segmentation results of the plurality of training texts to the neural network model to obtain a first intent result outputted by the neural network model for each training text;
calculating a loss function value according to the first intent results of the plurality of training texts and the first annotation intents of the plurality of training texts; and
adjusting parameters of the neural network model and the semantic vector of the candidate intent according to the calculated loss function value, until the neural network model converges, to obtain the intent recognition model.

5. The method according to claim 1, wherein the step of acquiring training data comprising a plurality of training texts and first annotation intents of the plurality of training texts comprises:
acquiring training data comprising the plurality of training texts, the first annotation intents of the plurality of training texts and second annotation intents of the plurality of training texts.

6. The method according to claim 5, wherein the step of constructing a neural network model comprising a feature extraction layer and a first recognition layer comprises:
constructing the neural network model comprising the feature extraction layer, the first recognition layer and a second recognition layer, the second recognition layer being configured to output, according to the first semantic vector of each segmented word in the training text outputted by the feature extraction layer, a second intent result of the training text.

7. The method according to claim 6, wherein the step of training the neural network model according to word segmentation results of the plurality of training texts and the first annotation intents of the plurality of training texts to obtain an intent recognition model comprises:
inputting the word segmentation results of the plurality of training texts to the neural network model to obtain the first intent result and the second intent result outputted by the neural network model for each training text;
calculating a first loss function value according to the first intent results of the plurality of training texts and the first annotation intents of the plurality of training texts, and calculating a second loss function value according to the second intent results of the plurality of training texts and the second annotation intents of the plurality of training texts; and
adjusting parameters of the neural network model and the semantic vector of the candidate intent according to the calculated first loss function value and second loss function value, until the neural network model converges, to obtain the intent recognition model.

8. A method for intent recognition, comprising:
acquiring a to-be-recognized text; and
inputting word segmentation results of the to-be-recognized text to an intent recognition model, and obtaining a first intent result and a second intent result of the to-be-recognized text according to an output result of the intent recognition model;
wherein the intent recognition model is pre-trained with the method according to claim 1.

9. The method according to claim 8, wherein the step of obtaining a first intent result and a second intent result of the to-be-recognized text according to an output result of the intent recognition model comprises:
obtaining the second intent result of the to-be-recognized text according to scores between segmented words in the to-be-recognized text and a candidate intent outputted by the intent recognition model.

10. An electronic device, comprising:
at least one processor; and
a memory communicatively connected with the at least one processor;
wherein the memory stores instructions executable by the at least one processor, and the instructions are executed by the at least one processor to enable the at least one processor to perform a method, wherein the method comprises:
acquiring training data comprising a plurality of training texts and first annotation intents of the plurality of training texts;
constructing a neural network model comprising a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and
training the neural network model according to word segmentation results of the plurality of training texts and the first annotation intents of the plurality of training texts to obtain an intent recognition model.

11. The electronic device according to claim 10, wherein the step of outputting, by the feature extraction layer, a first semantic vector of each segmented word in a training text comprises:
obtaining, for each training text, a word vector of each segmented word in the training text;
obtaining an encoding result and an attention calculation result of each segmented word according to the word vector of each segmented word; and
decoding a splicing result between the encoding result and the attention calculation result of each segmented word, and taking a decoding result as the first semantic vector of each segmented word.

12. The electronic device according to claim 10, wherein the step of outputting, by the first recognition layer according to a semantic vector of a candidate intent and a first semantic vector of each segmented word in a training text outputted by the feature extraction layer, a first intent result of the training text and a score between each segmented word in the training text and the candidate intent comprises:
obtaining, for each training text according to a first semantic vector of each segmented word in the training text and the semantic vector of the candidate intent, a second semantic vector of each segmented word and a score between each segmented word and the candidate intent; and
performing classification according to the second semantic vector of each segmented word, and taking a classification result as the first intent result of the training text.

13. The electronic device according to claim 10, wherein the step of training the neural network model according to word segmentation results of the plurality of training texts and the first annotation intents of the plurality of training texts to obtain an intent recognition model comprises:
inputting the word segmentation results of the plurality of training texts to the neural network model to obtain a first intent result outputted by the neural network model for each training text;
calculating a loss function value according to the first intent results of the plurality of training texts and the first annotation intents of the plurality of training texts; and
adjusting parameters of the neural network model and the semantic vector of the candidate intent according to the calculated loss function value, until the neural network model converges, to obtain the intent recognition model.

14. The electronic device according to claim 10, wherein the step of acquiring training data comprising a plurality of training texts and first annotation intents of the plurality of training texts comprises:
acquiring training data comprising the plurality of training texts, the first annotation intents of the plurality of training texts and second annotation intents of the plurality of training texts.

15. The electronic device according to claim 14, wherein the step of constructing a neural network model comprising a feature extraction layer and a first recognition layer comprises:
constructing the neural network model comprising the feature extraction layer, the first recognition layer and a second recognition layer, the second recognition layer being configured to output, according to the first semantic vector of each segmented word in the training text outputted by the feature extraction layer, a second intent result of the training text.

16. The electronic device according to claim 15, wherein the step of training the neural network model according to word segmentation results of the plurality of training texts and the first annotation intents of the plurality of training texts to obtain an intent recognition model comprises:
inputting the word segmentation results of the plurality of training texts to the neural network model to obtain the first intent result and the second intent result outputted by the neural network model for each training text;
calculating a first loss function value according to the first intent results of the plurality of training texts and the first annotation intents of the plurality of training texts, and calculating a second loss function value according to the second intent results of the plurality of training texts and the second annotation intents of the plurality of training texts; and
adjusting parameters of the neural network model and the semantic vector of the candidate intent according to the calculated first loss function value and second loss function value, until the neural network model converges, to obtain the intent recognition model.

17. A non-transitory computer readable storage medium with computer instructions stored thereon, wherein the computer instructions are used for causing a method, wherein the method comprises:
acquiring training data comprising a plurality of training texts and first annotation intents of the plurality of training texts;
constructing a neural network model comprising a feature extraction layer and a first recognition layer, the first recognition layer being configured to output, according to a semantic vector of a candidate intent and a first semantic vector of each segmented word in a training text outputted by the feature extraction layer, a first intent result of the training text and a score between each segmented word in the training text and the candidate intent; and
training the neural network model according to word segmentation results of the plurality of training texts and the first annotation intents of the plurality of training texts to obtain an intent recognition model.

18. The non-transitory computer readable storage medium according to claim 17, wherein the step of outputting, by the feature extraction layer, a first semantic vector of each segmented word in a training text comprises:
obtaining, for each training text, a word vector of each segmented word in the training text;
obtaining an encoding result and an attention calculation result of each segmented word according to the word vector of each segmented word; and
decoding a splicing result between the encoding result and the attention calculation result of each segmented word, and taking a decoding result as the first semantic vector of each segmented word.

19. The non-transitory computer readable storage medium according to claim 17, wherein the step of outputting, by the first recognition layer according to a semantic vector of a candidate intent and a first semantic vector of each segmented word in a training text outputted by the feature extraction layer, a first intent result of the training text and a score between each segmented word in the training text and the candidate intent comprises:
obtaining, for each training text according to a first semantic vector of each segmented word in the training text and the semantic vector of the candidate intent, a second semantic vector of each segmented word and a score between each segmented word and the candidate intent; and
performing classification according to the second semantic vector of each segmented word, and taking a classification result as the first intent result of the training text.

20. The non-transitory computer readable storage medium according to claim 17, wherein the step of training the neural network model according to word segmentation results of the plurality of training texts and the first annotation intents of the plurality of training texts to obtain an intent recognition model comprises:
inputting the word segmentation results of the plurality of training texts to the neural network model to obtain a first intent result outputted by the neural network model for each training text;
calculating a loss function value according to the first intent results of the plurality of training texts and the first annotation intents of the plurality of training texts; and
adjusting parameters of the neural network model and the semantic vector of the candidate intent according to the calculated loss function value, until the neural network model converges, to obtain the intent recognition model.
